(19) United States
(12) Patent Application Publication
(10) Pub. No.: US 2011/0019406 A1
(43) Pub. Date: Jan. 27, 2011

(54) REFLECTING COVER AND ILLUMINATION DEVICE USING THE SAME

(75) Inventors: CHIAO-LING PENG, Chu-Nan (TW); TIEN-PAO CHEN, Chu-Nan (TW); PEI-YUAN HUNG, Chu-Nan (TW); HSUEH-CHEN CHANG, Chu-Nan (TW); CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/775,492

(22) Filed: May 7, 2010

(30) Foreign Application Priority Data
Jul. 24, 2009 (CN) 200910304836.X

(51) Int. Cl. F21V 1/00; F21V 7/00

(52) U.S. Cl. 362/235; 362/341

(57) ABSTRACT

A reflecting cover includes a substrate and a reflecting ring. The substrate is configured for receiving an LED. The reflecting ring is mounted on the substrate. The reflecting ring includes a plurality of reflecting units. The reflecting units are configured for reflecting light of the LED. The angles of the reflecting units relative to the substrate increase in turn along a direction away from the substrate.

### BACKGROUND

1. Technical Field

The disclosure relates generally to illumination, and more particularly to an illumination device utilizing a reflecting system.

2. Description of the Related Art

With the development of LED-based illumination, effective distribution of generated light is a priority. One method to obtain specific illumination distribution utilizes a plurality of light sources with determined light emitting angles. The requisite device is, however, bulky and expensive. In a second method, a specific lens array is utilized adjusting the light emission angle. However, such a lens array is very expensive. Further, when the light is transmitted through the lens array, much light energy is lost. Thus, what is called for is an illumination device utilizing a reflecting system that can alleviate the limitations described.

### BRIEF DESCRIPTION OF THE DRAWINGS

FIG. 1 is a perspective view of a reflecting cover in accordance with a first embodiment of the disclosure.

FIG. 2 is a cross-section along line II-II of the reflecting cover in FIG. 1.

FIG. 3 is a cross-section of a reflecting cover in accordance with a second embodiment of the disclosure.

FIG. 4 is an exploded view of an illumination device in accordance with a third embodiment of the disclosure.

FIG. 5 is an exploded view of an illumination device in accordance with a fourth embodiment of the disclosure.

### DETAILED DESCRIPTION

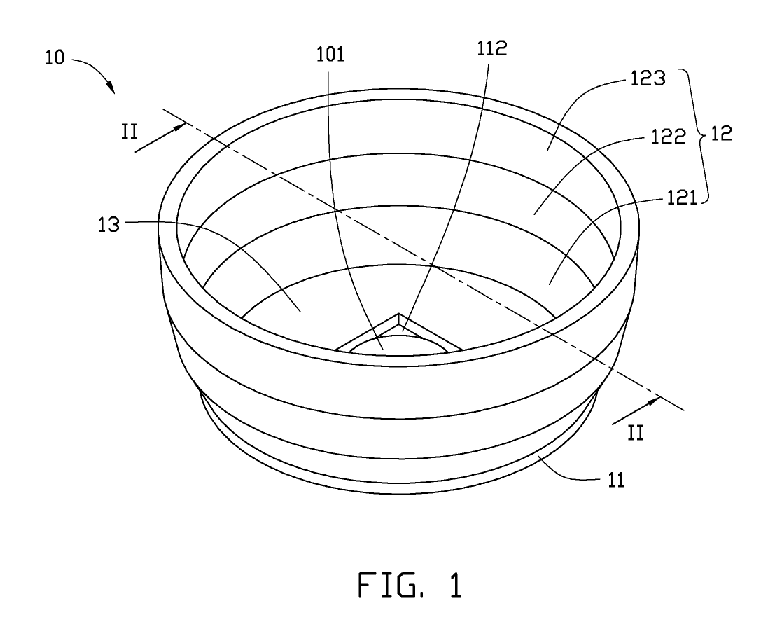

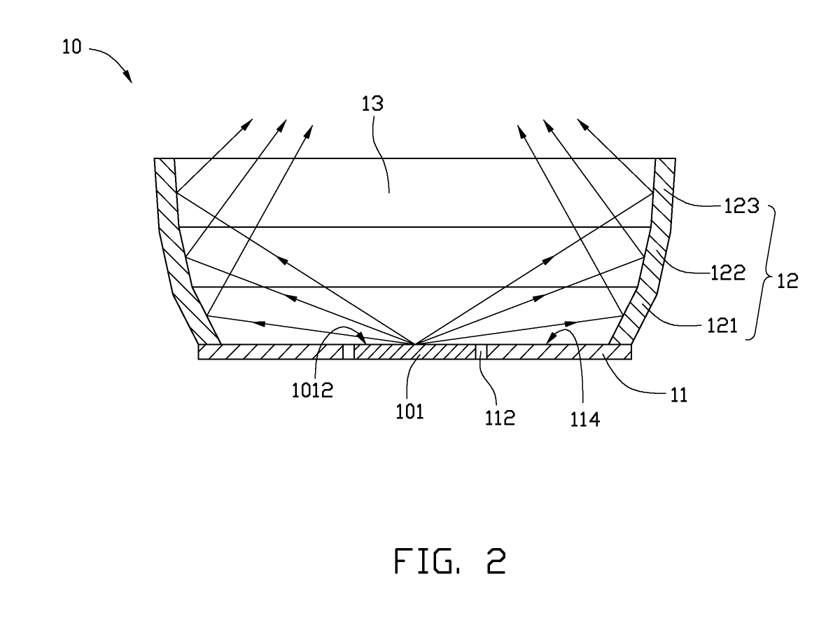

Referring to FIG. 1 and FIG. 2, a reflecting cover 10 in accordance with a first embodiment of the disclosure includes a substrate 11 and a reflecting ring 12. The reflecting cover 10 is configured for adjusting the illumination distribution of a light emitting diode (LED) 101.

A receiving portion 112 is defined in the middle of the substrate 11. The receiving portion 112 is configured for receiving the LED 101. The substrate 11 is a transparent plate of glass or resin. The receiving portion 112 is a through-hole in the first embodiment. Optimally, the light emitting surface 1012 of the LED 101 is parallel to and coplanar with the upper surface 114 of the substrate 11.

The reflecting ring 12 is mounted on the substrate 11. A chamber 13 is formed by the substrate 11 and the reflecting ring 12 cooperatively. The reflecting ring 12 includes a first reflecting unit 121, a second reflecting unit 122 and a third reflecting unit 123. Here, the first reflecting unit 121, the second reflecting unit 122 and the third reflecting unit 123 are annular, but can, alternatively, have other shapes, such as rectangle or other. The angle of the third reflecting unit 123 relative to the substrate 11 exceeds that of the second reflecting unit 122 relative to the substrate 11. The angle of the second reflecting unit 122 relative to the substrate 11 exceeds that of the first reflecting unit 121 relative to the substrate 11. In other words, the third reflecting unit 123 is steeper than the second reflecting unit 122 which in turn is steeper than the first reflecting unit 121.

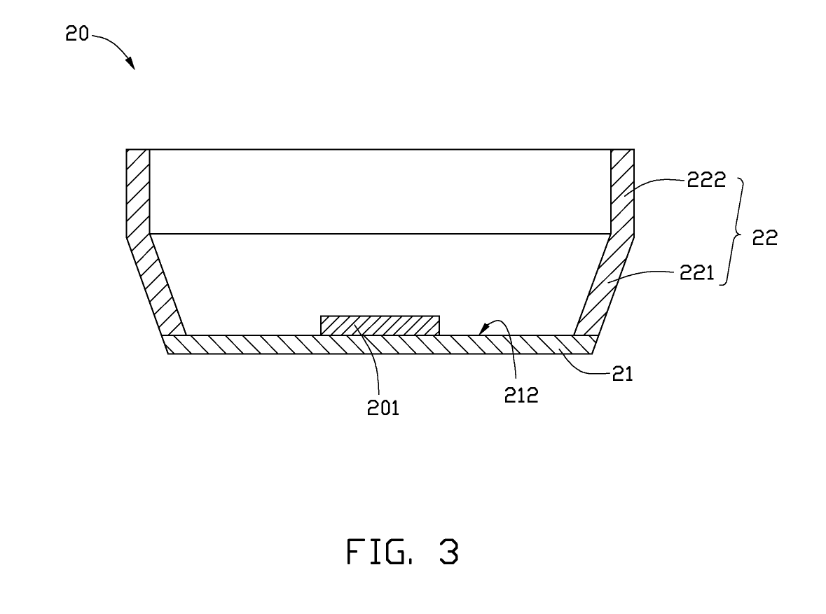

Referring to FIG. 3, a reflecting cover 20 in accordance with a second embodiment of the disclosure differs from the first embodiment in that an LED 201 is mounted on the middle of the mounting surface 212, whereby a top light emitting surface (not labeled) of the LED 201 is parallel to and above the mounting surface 212 of the substrate 21, in which the mounting surface 212 is an upper surface of the substrate 21.

The reflecting ring 22 includes a first reflecting unit 221 and a second reflecting unit 222 mounted on the substrate 21. The first reflecting unit 221 is adjacent to the substrate 21, configured for reflecting light from the LED 201. The first reflecting unit 221 has a predetermined angle relative to the substrate 21. The second reflecting unit 222 extends upwardly from a top edge of the first reflecting unit 221 and is perpendicular to the substrate 21.

The light from the LED 201 is reflected by the first reflecting unit 221 and the second reflecting unit 222. Thus specific illumination distribution of the light of the LED 201 is obtained.

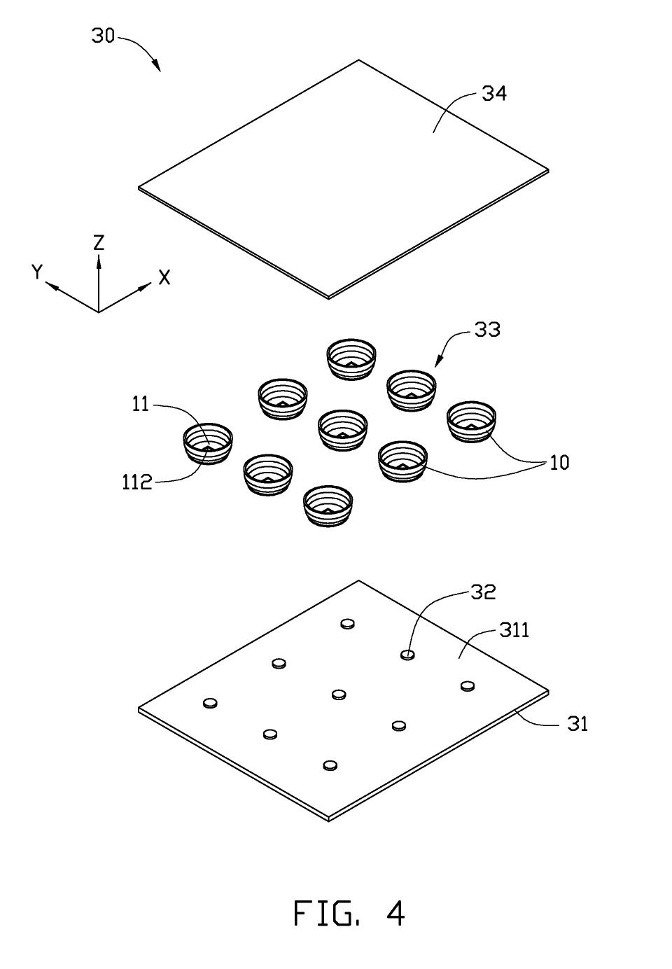

Referring to FIG. 4, an illumination device 30 in accordance with a third embodiment of the disclosure includes a substrate 31, a plurality of LEDs 32, a reflecting module 33 and a transparent plate 34.

The LEDs 32 are mounted on a surface 311 of the substrate 31. The LEDs 32 are electrically connected to the substrate 31. The substrate 31 is electrically connected to a peripheral power supply (not shown).

The reflecting module 33 includes a plurality of reflecting covers 10 each being as that shown in the first embodiment. The reflecting covers 10 are mounted on the surface 311 of the substrate 31. Each LED 32 is received in one of the reflecting covers 10.

The transparent plate 34 is mounted on the reflecting module 33. The transparent plate 34 is opposite to the surface 311 of the substrate 31, configured for enveloping the reflecting module 33 and uniformly transmitting the light from the reflecting module 33.

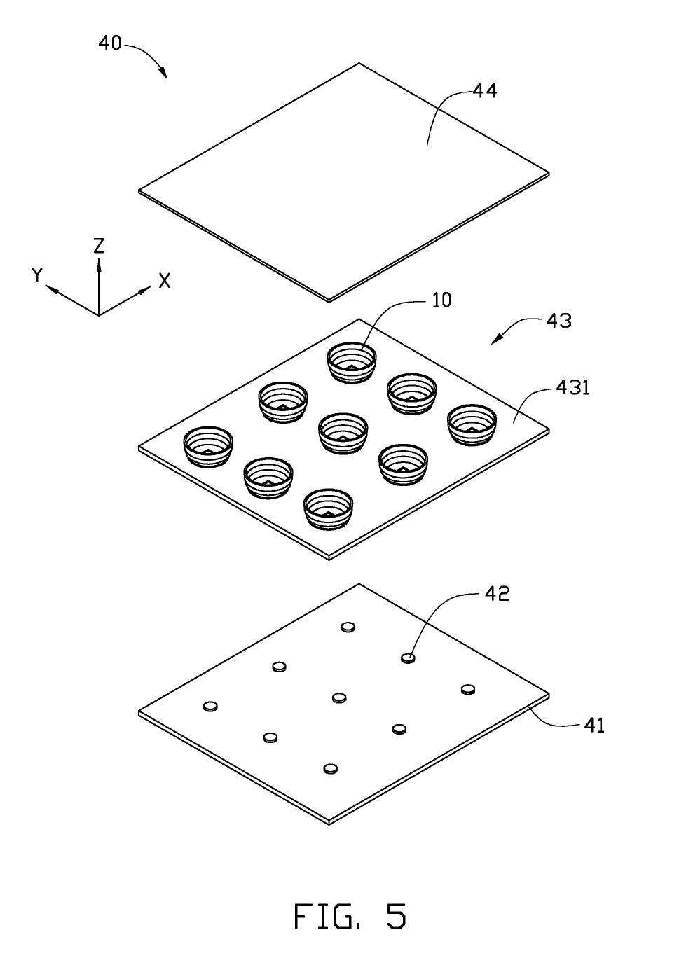

Referring to FIG. 5, an illumination device 40 in accordance with a fourth embodiment of the disclosure includes a substrate 41, a plurality of LEDs 42, a reflecting module 43 and a transparent plate 44.

The LEDs 42 are mounted on the substrate 41. The reflecting module 43 includes a substrate 431 and a plurality of reflecting covers 10 each being as that shown in the first embodiment. The reflecting covers 10 are mounted on the substrate 431 in matrix array. Compared with the third embodiment, the illumination device 40 can be more easily assembled since the reflecting covers 10 are assembled to the substrate 431 as a unit in advance whereby the reflecting covers 10 can be moved to cover all of the LEDs 42 by a single step of operation.

The structure of the reflecting cover 10, while simple and easily manufactured, provides specific illumination distribution. Production costs of an illumination device utilizing the reflecting cover 10 decreases accordingly.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reflecting cover comprising:
a substrate, in the middle of which a receiving portion is defined, the receiving portion configured for receiving a light source which is a solid-state light emitting device; and
a reflecting ring mounted on the substrate and comprising a plurality of reflecting units configured for reflecting light from the light source, wherein the angles of the reflecting units relative to the substrate increasing in turn along a direction away from the substrate.

2. The reflecting cover as claimed in claim 1, wherein one of the reflecting units is perpendicular to the substrate.

3. The reflecting cover as claimed in claim 1, wherein a receiving portion is defined in the middle of the substrate and configured for receiving the light source.

4. The reflecting cover as claimed in claim 1, wherein the receiving portion is a through hole.

5. The reflecting cover as claimed in claim 1, wherein the reflecting units of the reflecting cover are annular.

6. The illumination device as claimed in claim 1, wherein the reflecting units are rectangular.

7. An illumination device comprising:
a substrate;
a plurality of light sources mounted on the substrate, wherein the light sources are solid-state light emitting devices;
a reflecting module comprising a plurality of reflecting covers, each of the reflecting covers comprising a substrate and a reflecting ring, a receiving portion defined in the middle of the substrate, the reflecting ring comprising a plurality of reflecting units mounted on and extending away from the substrate, the reflecting units configured for reflecting light, the angles of the reflecting units relative to the substrate increasing in turn along a direction away from the substrate.

8. The illumination device as claimed in claim 7, wherein the illumination device further comprises a transparent plate configured for enveloping the reflecting module and located opposite to the light sources.

9. The illumination device as claimed in claim 7, wherein the reflecting module further comprises a mounting plate on one surface of which the light sources are mounted in matrix array.

10. The illumination device as claimed in claim 7, wherein one of the reflecting units is perpendicular to the substrate.

11. The illumination device as claimed in claim 7, wherein the reflecting units are annular.

12. The illumination device as claimed in claim 7, wherein the reflecting units are rectangular.
